(19) United States
(12) Patent Application Publication
(10) Pub. No.: US 2024/0228290 A1
(43) Pub. Date: Jul. 11, 2024

(54) ARTICLES COMPRISING FULLERENE MATERIALS AND CARBON NANOTUBES

(71) Applicant: Government of the United States, as represented by the Secretary of the Air Force, Wright-Patterson AFB, OH (US)

(72) Inventor: John S. Bulmer, Dayton, OH (US)

(21) Appl. No.: 18/537,136

(22) Filed: Dec. 12, 2023

Related U.S. Application Data
(60) Provisional application No. 63/601,328, filed on Nov. 21, 2023.
(60) Provisional application No. 63/461,440, filed on Apr. 24, 2023.
(60) Provisional application No. 63/437,866, filed on Jan. 9, 2023.

(51) Int. Cl. C01B 32/152; C01B 32/158

(52) U.S. Cl. CPC C01B 32/152; C01B 32/158; C01P 2002/01; C01P 2002/70; C01P 2002/82

(57) ABSTRACT

The present invention relates to articles comprising fullerene supramolecular crystals and/or amorphous fullerene agglomerations, as well as carbon nanotubes (CNTs) and processes of making and using same. The disclosed articles have increased mechanical strength and flexibility while unexpectantly having an electrical conductivity that is similar to carbon nanotubes (CNTs) containing articles that do not contain fullerene supramolecular crystals and/or amorphous fullerene agglomerations. Such improved articles can be used in areas including cryogenics and aerospace. Applicants also provide an improved process of making the improved articles.

### CROSS-REFERENCE TO RELATED APPLICATIONS

The present application claims priority to U.S. Provisional Application Ser. No. 63/601,328 filed Nov. 21, 2023, U.S. Provisional Application Ser. No. 63/461,440 filed Apr. 24, 2023, and U.S. Provisional Application Ser. No. 63/437,866 filed Jan. 9, 2023, the contents of both such provisional applications hereby being incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to articles comprising fullerene supramolecular crystals and/or amorphous fullerene agglomerations, as well as carbon nanotubes and processes of making and using same.

### BACKGROUND OF THE INVENTION

Current articles such as fibers, sheets and tapes that comprise carbon nanotubes (CNTs) are envisioned as a replacement for metal wire, as well as certain sheeting and tapes as they are light weight, reasonably mechanically strong and electrically conductive. Such articles are also envisioned for use in applications such as body armor. One of the drawbacks that keep such articles from being implemented is limited electrical conductivity and/or the mechanical strength of the current articles.

Applicants discovered that the mechanical strength and flexibility of articles that comprise carbon nanotubes (CNTs) can be improved by the addition of fullerene supramolecular crystals and/or amorphous fullerene agglomerations to the articles. An added benefit is that when fullerene supramolecular crystals and/or amorphous fullerene agglomerations are added to such articles, the articles' electrical conductivity is maintained even though fullerene supramolecular crystals and amorphous fullerene agglomerations, singularly or in combination would be expected to disturb the alignment of the carbon nanotubes (CNTs) in the article thus leading to decreased electrical conductivity. Without being bounded by theory, such improved properties are obtained, at least in part, by applying pressure to a solution comprising carbon nanotubes (CNTs) and fullerenes during the process of producing Applicants' articles. Applicants surprisingly discovered that the fullerenes self-assemble into supramolecular crystal structures that align with the carbon nanotubes or amorphous fullerene agglomerations that align with the carbon nanotubes. Further, the carbon nanotubes themselves maintained a high degree of alignment, despite the presence of the embedded fullerene supramolecular crystal structures and/or amorphous fullerene agglomerations that align with the carbon nanotubes. Applicants believe that such alignment phenomena result in the superior properties of Applicants articles.

### SUMMARY OF THE INVENTION

The present invention relates to articles comprising fullerene supramolecular crystals and/or amorphous fullerene agglomerations, as well as carbon nanotubes (CNTs) and processes of making and using same. The disclosed articles have increased mechanical strength and flexibility while unexpectantly having an electrical conductivity that is similar to carbon nanotubes (CNTs) containing articles that do not contain fullerene supramolecular crystals and/or amorphous fullerene agglomerations. Such improved articles can be used in areas including cryogenics and aerospace. Applicants also provide an improved process of making the improved articles.

Additional objects, advantages, and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is an image depicting transmission wide angle X-ray diffraction (WAXD) of the novel material we disclose here in a higher C60 concentration (2% C60, 2% carbon nanotube (CNT), 96% chlorosulfonic acid (CSA) by wt % at mixing), in an as-is state. Color represents intensity, as a function of scattering vector Q and the azimuthal angle ψ.

FIG. 1B is an image depicting transmission wide angle X-ray diffraction (WAXD) of the novel material we disclose here in a higher C60 concentration (2% C60, 2% carbon nanotube (CNT), 96% chlorosulfonic acid (CSA) by wt % at mixing), in an annealed state. Color represents intensity, as a function of scattering vector Q and the azimuthal angle TI.

FIG. 1C is an image depicting transmission wide angle X-ray diffraction (WAXD) of the novel material we disclose here in a lower C60 concentration (0.2% C60, 2% carbon nanotube (CNT), 97.8% chlorosulfonic acid (CSA) by wt % at mixing) in an as-is state. Color represents intensity, as a function of scattering vector Q and the azimuthal angle TI.

FIG. 1D is an image depicting transmission wide angle X-ray diffraction (WAXD) of the novel material we disclose here in a lower C60 concentration (0.2% C60, 2% carbon nanotube (CNT), 97.8% chlorosulfonic acid (CSA) by wt % at mixing) in an annealed state. Color represents intensity, as a function of scattering vector Q and the azimuthal angle TI.

FIG. 1E is an image depicting transmission wide angle X-ray diffraction (WAXD) of a neat carbon nanotube (CNT) fiber (0% C60, 2% carbon nanotube (CNT), 98% chlorosulfonic acid (CSA) by wt % at mixing), in an as-is state. Color represents intensity, as a function of scattering vector Q and the azimuthal angle ψ.

FIG. 1F is an image depicting transmission wide angle X-ray diffraction (WAXD) of a neat carbon nanotube (CNT) fiber (0% C60, 2% carbon nanotube (CNT), 98% chlorosulfonic acid (CSA) by wt % at mixing), in an annealed state. Color represents intensity, as a function of scattering vector Q and the azimuthal angle ψ.

FIG. 2A is a plot depicting select transmission wide angle X-ray diffraction (WAXD) results again of an annealed neat carbon nanotube (CNT) fiber, with the azimuthal angle ψ being integrated out.

FIG. 2B is a plot depicting select transmission wide angle X-ray diffraction (WAXD) results again of a crystalline phase of C60 powder, with the azimuthal angle ψ being integrated out.

FIG. 2C is a plot depicting select transmission wide angle X-ray diffraction (WAXD) results again of higher concentration (2% C60, 2% carbon nanotube (CNT), 96% chlorosulfonic acid (CSA) by wt % at mixing) C60 load carbon nanotube (CNT) fiber, in an annealed state, with the azimuthal angle ψ being integrated out. Note that this plot is a near superposition of FIG. 2A and FIG. 2B.

FIG. 3A is an NanoCT scan image showing real-space internal structure of the novel material we disclose here, in this case of the lower C60 concentration (0.2% C60, 2% carbon nanotube (CNT), 97.8% chlorosulfonic acid (CSA) by wt %) in an as-is state. The color bar indicates the change of phase, representing differences in density.

FIG. 3B is an NanoCT scan image showing real-space internal structure of the novel material we disclose here, in this case of the higher C60 concentration (2% C60, 2% carbon nanotube (CNT), 96% chlorosulfonic acid (CSA) by wt %) in an as-is state. The color bar indicates the change of phase, representing differences in density.

FIG. 3C is a Transmission Electron Microscope (TEM) photograph showing real-space internal structure of the novel material we disclose here, in this case of the lower C60 concentration (0.2% C60, 2% carbon nanotube (CNT), 97.8% chlorosulfonic acid (CSA) by wt %) in an as-is state. The arrow indicating fiber direction. Prominent streaks running up and down are a curtaining artifact. This shows inclusions that are C60 agglomerations, which are in aligned rows. Transmission electron microscopy (TEM) diffraction results and wide angle X-ray diffraction (WAXD) results support that these C60 agglomerations less crystalline than in the case of the higher C60 concentrations.

FIG. 3D is a Transmission Electron Microscope (TEM) photograph showing real-space internal structure of the novel material we disclose here, in this case of the higher C60 concentration (2% C60, 2% carbon nanotube (CNT), 96% chlorosulfonic acid (CSA) by wt %) in an as-is state. The arrow indicating fiber direction. This higher concentration version shows larger C60 agglomerations, which Transmission electron microscopy (TEM) diffraction results and wide angle X-ray diffraction (WAXD) results support these larger inclusions are more crystalline than in the case of the lower C60 concentrations.

FIG. 3E is a high-resolution Transmission Electron Microscope (TEM) photograph showing real-space internal structure of the novel material we disclose here, in this case of the higher C60 concentration (2% C60, 2% carbon nanotube (CNT), 96% chlorosulfonic acid (CSA) by wt %) version in an as-is state, of one of the larger granular inclusions.

FIG. 3F is a high-resolution Transmission Electron Microscope (TEM) electron diffraction pattern of the larger granular inclusions, in this case of the as-is, higher C60 concentration (2% C60, 2% carbon nanotube (CNT), 96% chlorosulfonic acid (CSA) by wt %) version.

FIG. 4A is a plot of a Raman spectrum (514 nm Raman laser wavelength) of an as-is lower C60 concentration (0.2% C60, 2% carbon nanotube (CNT), 97.8% chlorosulfonic acid (CSA) by wt %) of the novel material we disclose here, with the fiber microstructure aligned with the Raman laser polarization. When polarization is parallel to the carbon nanotube (CNT) microstructure alignment, the spectra are more typical of carbon nanotube (CNT) spectra.

FIG. 4B is a plot of a Raman spectrum (514 nm Raman laser wavelength) of an as-is lower C60 concentration (0.2% C60, 2% carbon nanotube (CNT), 97.8% chlorosulfonic acid (CSA) by wt %) of the novel material we disclose here, with the fiber microstructure aligned perpendicular to the Raman laser polarization. When polarization is perpendicular to the carbon nanotube (CNT) microstructure alignment, the fullerene Raman features become more apparent.

FIG. 4C is a plot of a Raman spectrum (514 nm Raman laser wavelength) of an as-is higher C60 concentration (2% C60, 2% carbon nanotube (CNT), 96% chlorosulfonic acid (CSA) by wt %) of the novel material we disclose here, with the fiber microstructure aligned with the Raman laser polarization. When polarization is parallel to the carbon nanotube (CNT) microstructure alignment, the spectra are more typical of carbon nanotube (CNT) spectra.

FIG. 4D is a plot of a Raman spectrum (514 nm Raman laser wavelength) of an as-is higher C60 concentration (2% C60, 2% carbon nanotube (CNT), 96% chlorosulfonic acid (CSA) by wt %) of the novel material we disclose here, with the fiber microstructure aligned perpendicular to the Raman laser polarization. When polarization is perpendicular to the carbon nanotube (CNT) microstructure alignment, the fullerene Raman features become more apparent.

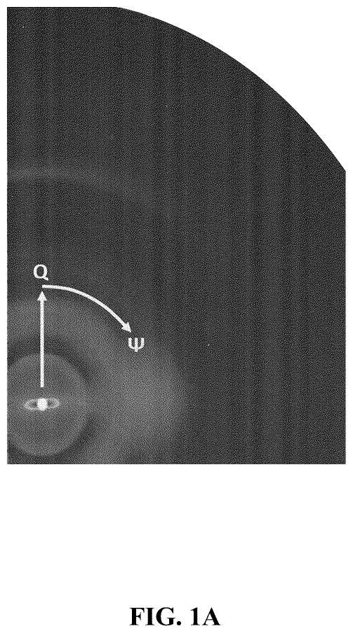

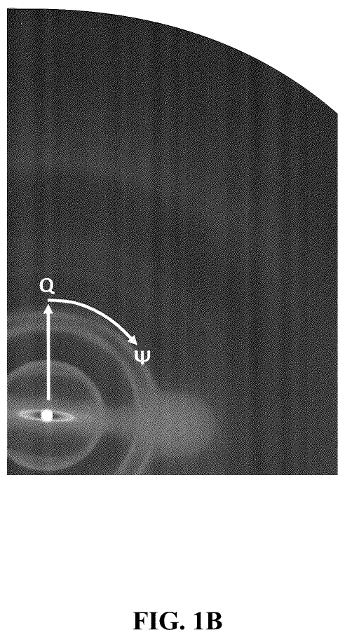

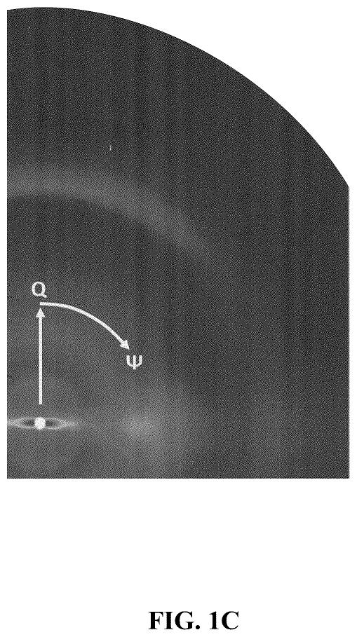

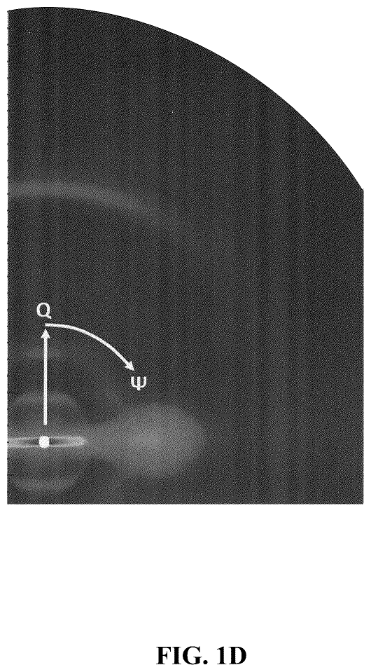

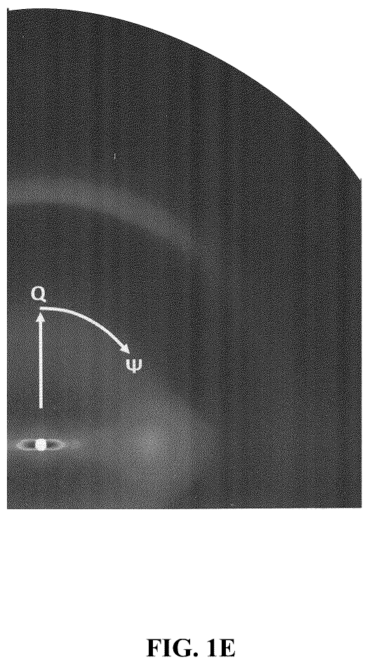

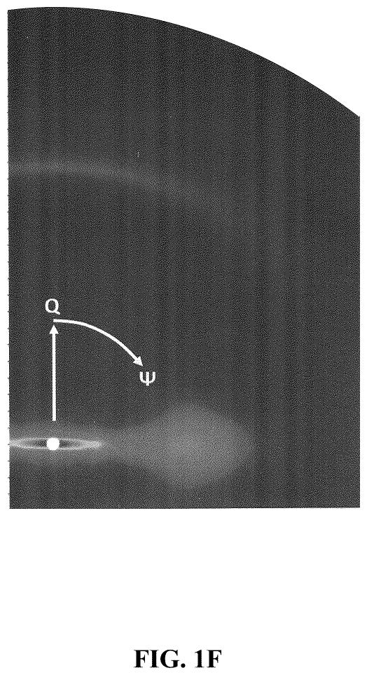

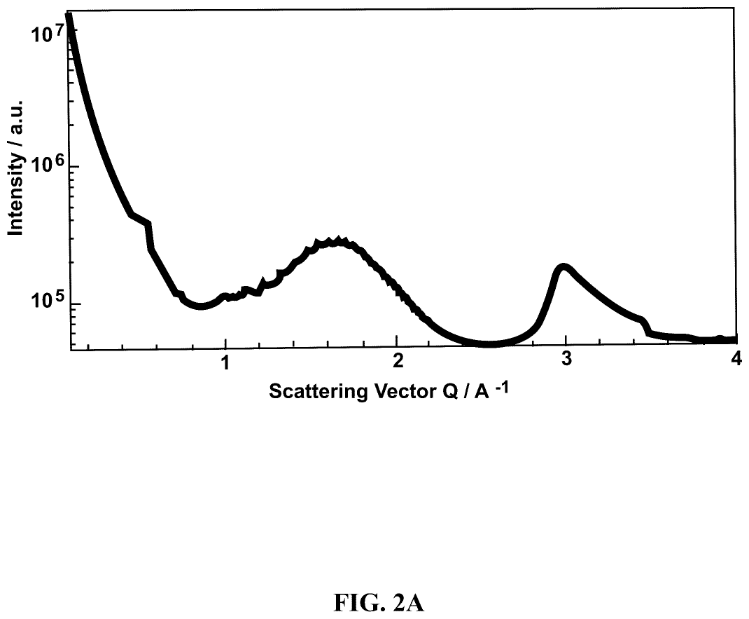

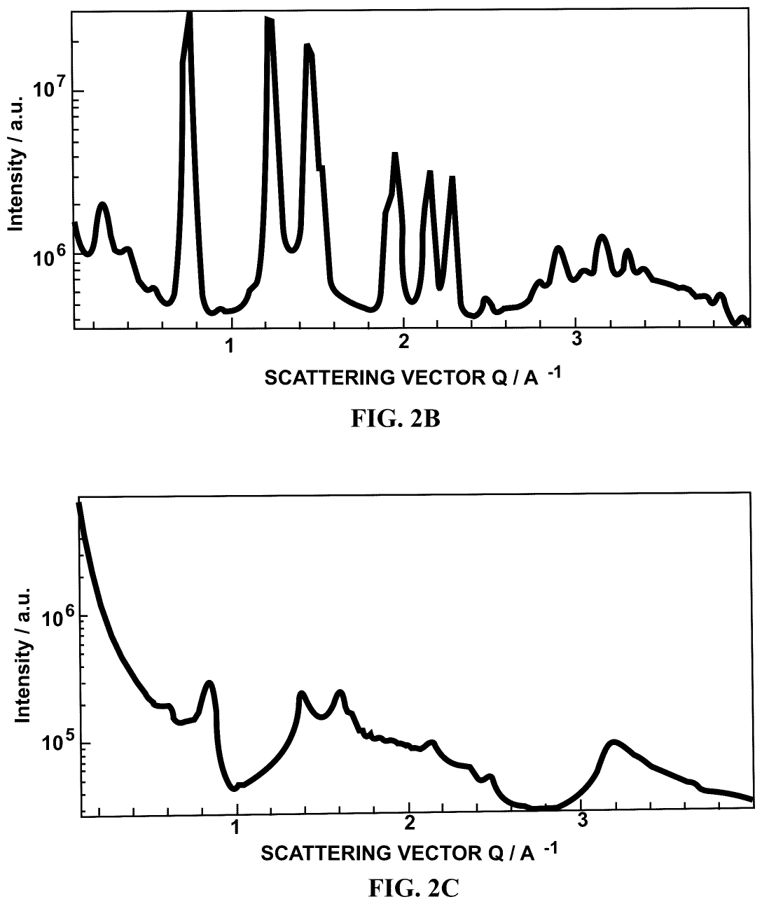

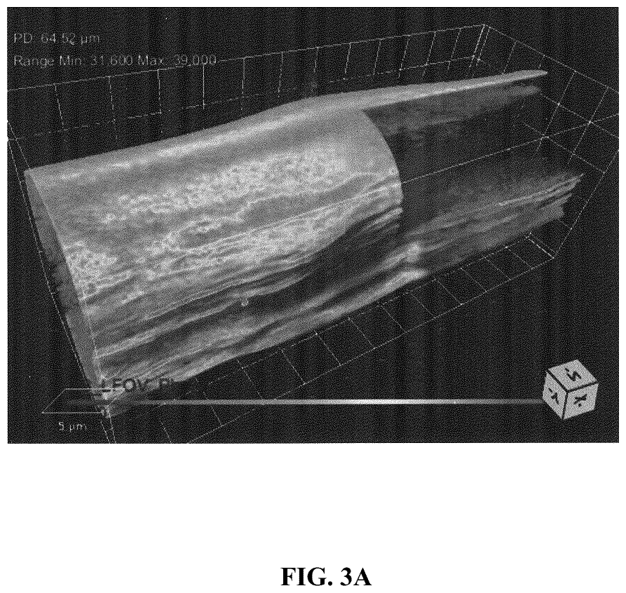

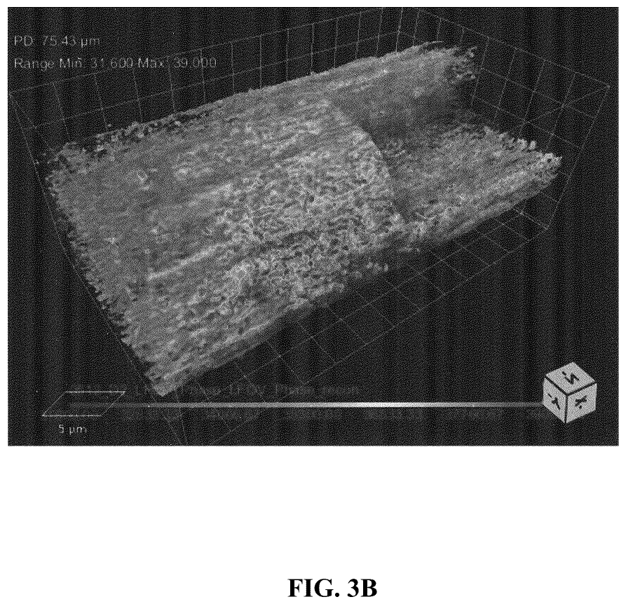

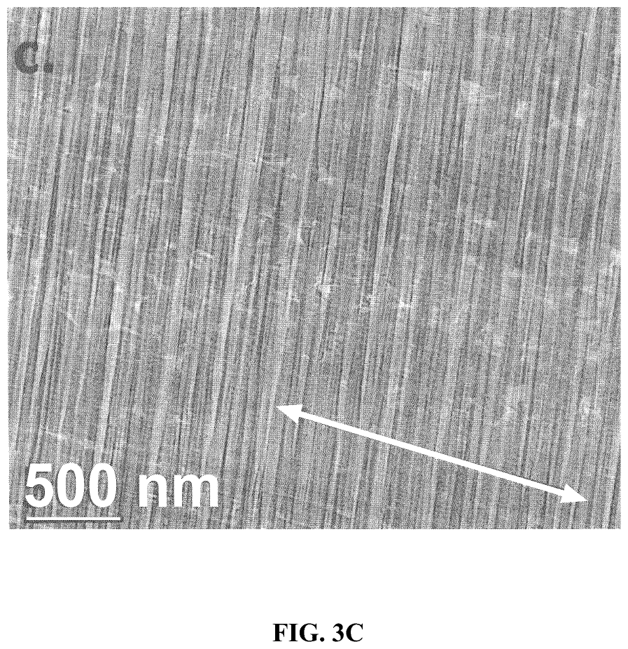

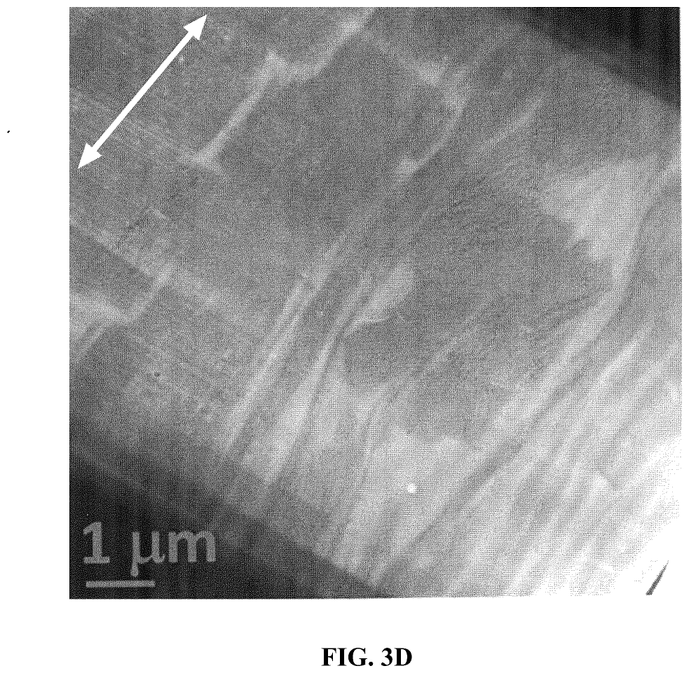

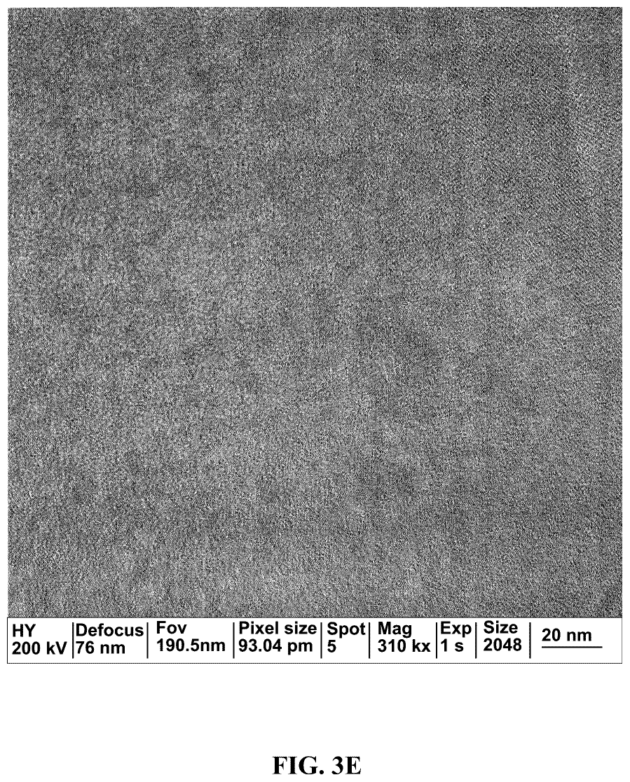

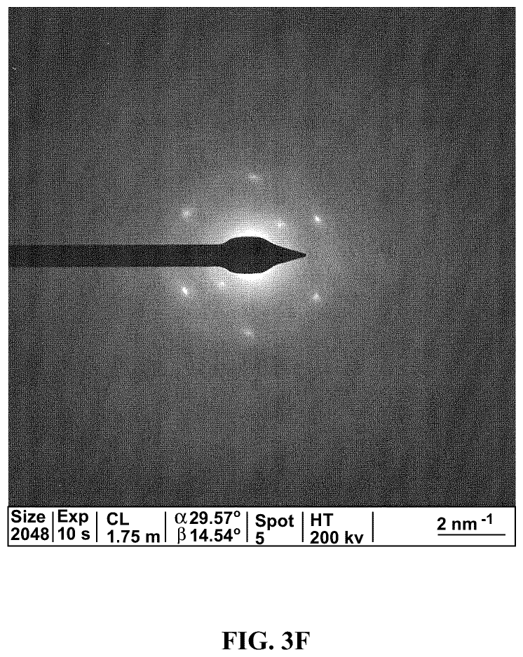

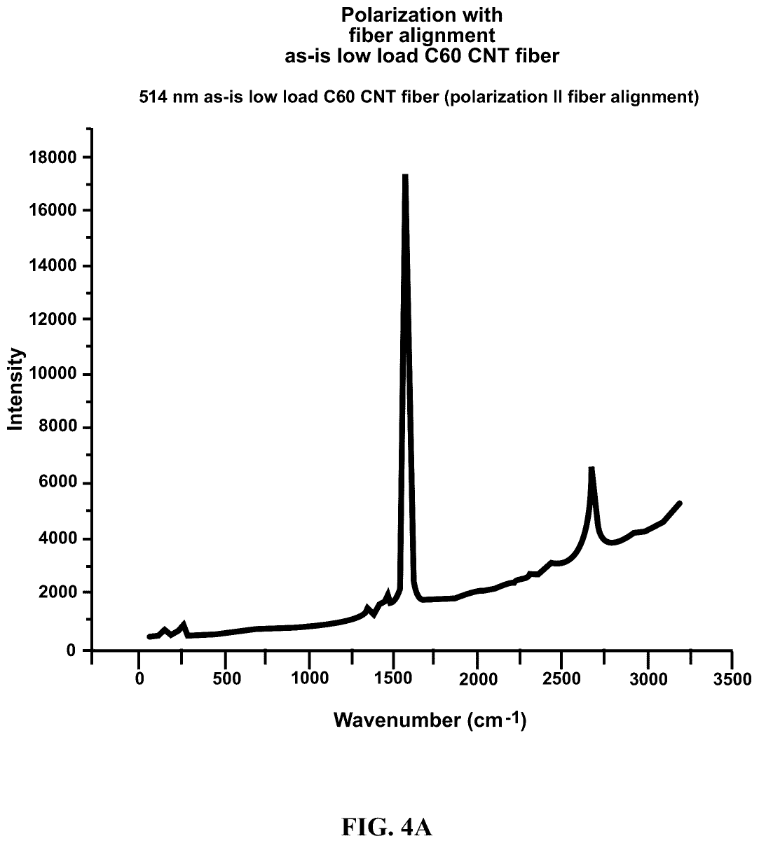

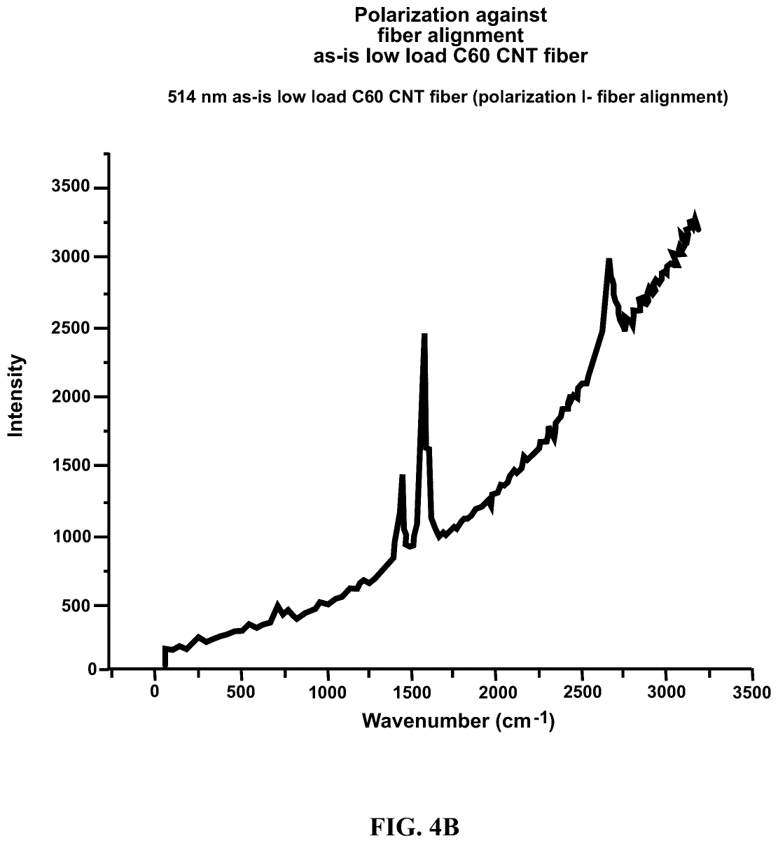

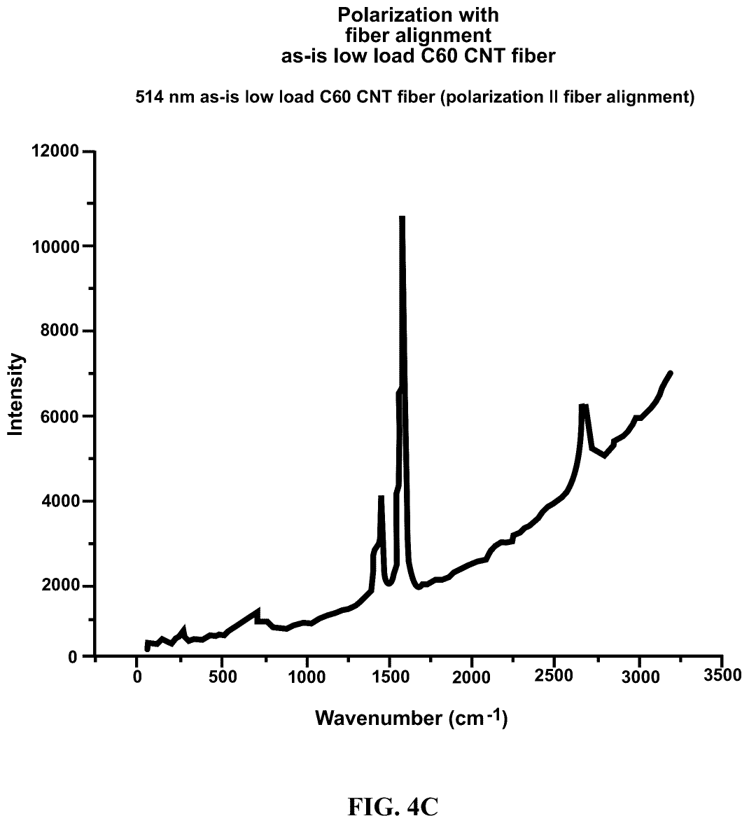

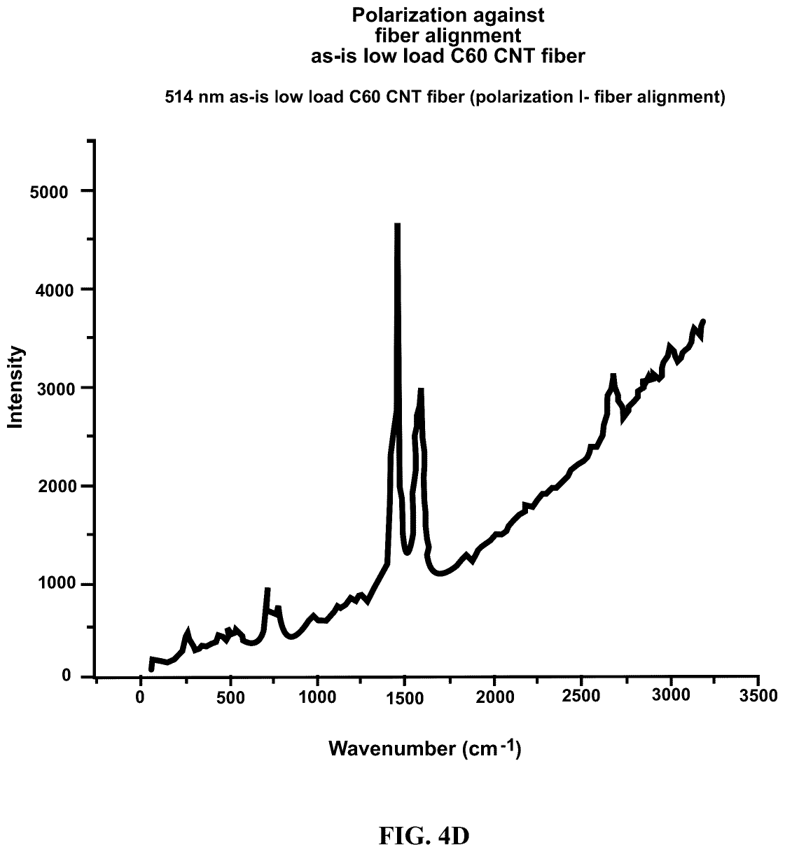

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “and/or” means, when referring to embodiments (for example an embodiment having elements A and/or B) that the embodiment may have element A alone, element B alone, or elements A and B taken together.

As used herein, the words “about,” “approximately,” or the like, when accompanying a numerical value, are to be construed as indicating a deviation as would be appreciated by one of ordinary skill in the art to operate satisfactorily for an intended purpose.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein aerospace vehicle means the vehicle's listed in Table 1 below;

TABLE 1
Aerospace Vehicle Type and Modes of Guidance, Navigation, and Control

| | | |
|---|---|---|
| Vehicle | GNC Methods | Maneuver Method |

AIR

| | | |
|---|---|---|
| Weather Balloon | radiosonde, theodolite | pressure inside balloon |
| Manned aircraft | altimeter, inertial navigation system | thrust, flight control |
| | (INS), Global Positioning System (GPS) | surfaces |
| Unmanned aircraft | altimeter, INS, GPS | thrust, flight control |
| | | surfaces |
| Quadcopter | visual sensor, GPS | propeller(s) |
| Airborne Missile | altimeter, INS, GPS | thrust, flight control |
| | | surfaces |

AEROSPACE

| | | |
|---|---|---|
| Scientific Balloon | star camera, altimeter | pressure inside balloon |
| Sounding Rocket | ring laser gyro, altimeter, accelerometers | thrust, flight control |
| | | surfaces |
| Space Shuttle | human-in-the-loop, star camera | thrust, flight control |
| | | surfaces |
| Launch Vehicle | INS, ring laser gyro, altimeter, | thrust, flight control |
| (Rocket) | accelerometers | surfaces |
| Ballistic Missile | INS, GPS | thrust, flight control |
| | | surfaces |

SPACE

| | | |
|---|---|---|
| Satellite | star camera, sun sensor, horizon sensor, | thruster, electric propulsion, |
| | GPS | magnetorquer, momentum |
| | | wheel |
| Space Station | human, star camera, sun sensor, horizon | thruster, electric propulsion, |
| | sensor, GPS | magnetorquer, momentum |
| | | wheel |
| Interplanetary | star camera, sun sensor | thruster, electric propulsion, |
| Vehicle | | momentum wheel |

Examples of Flight Control Surfaces: Fins, Ailerons, Elevators.
Thrust includes the two-directional thrust force, as well as any gimbaled thrust vectoring the vehicle is capable of generating.

### Fiber Comprising Fullerene Supramolecular Crystals and Carbon Nanotube Bundles

For purposes of this specification, headings are not considered paragraphs. The individual number of each paragraph above and below this paragraph can be determined by reference to this paragraph. In this paragraph, Applicants disclose an article comprising: aligned carbon nanotubes; and fullerene supramolecular crystals and/or amorphous agglomerations of fullerenes. In one aspect, said aligned carbon nanotubes may be in the form of bundles and may be single-wall carbon nanotubes, double wall carbon nanotubes, multi-walled carbon nanotubes, ultrashort carbon nanotubes, small diameter carbon nanotubes, and/or functionalized carbon nanotubes.

Applicants disclose the article of the previous paragraph wherein said fullerene supramolecular crystals are aligned.

Applicants disclose the article of the previous two paragraphs wherein said fullerene supramolecular crystals are aligned with said aligned carbon nanotubes, said aligned fullerene supramolecular crystals and said aligned carbon nanotubes having a difference in alignment of from 90° to 0°, preferably said aligned fullerene supramolecular crystals and said aligned carbon nanotubes have a difference in alignment of from about 45° to about 1, more preferably said aligned fullerene supramolecular crystals and said aligned carbon nanotubes having a difference in alignment of from about 20° to about 2°, most preferably said aligned fullerene supramolecular crystals and said aligned carbon nanotubes having a difference in alignment of from about 10° to about 3°.

Applicants disclose the article of the previous three paragraphs wherein said fullerene supramolecular crystals have a maximum dimension of from about 1 nm to about 50 mm, preferably said fullerene supramolecular crystals have a maximum dimension of from about 5 nm to about 100 μm, more preferably said fullerene supramolecular crystals have a maximum dimension of from about 20 nm to about 10 μm, most preferably said fullerene supramolecular crystals have a maximum dimension of from about 50 nm to about 1 μm.

Applicants disclose the article of the previous four paragraphs wherein said fullerene supramolecular crystals have a crystal structure that is face centered cubic, body centered cubic, simple cubic, polymerized in one dimensional chains, polymerized in two dimensional chains, polymerized in three dimensional structures, and/or dimerized.

Applicants disclose the article of the previous five paragraphs wherein said fullerene supramolecular crystals have an overall outer shape of whiskers, needles, tubular rods, rings, platelets, spheres, cubes, rhombuses, sheets, cones, ellipsoids, and/or prisms.

Applicants disclose the article of the previous six paragraphs wherein said fullerene supramolecular crystals' maximum dimension is oriented in the direction of the carbon nanotube alignment where the angle difference for at least 50% of the fullerene supramolecular crystals' maximum dimension to the carbon nanotube alignment is from about 45° to 0°; preferably the angle difference for at least 50% of the fullerene supramolecular crystals' maximum dimension to the carbon nanotube alignment is from about 30° to about 1°; more preferably the angle difference for at least 50% of the fullerene supramolecular crystals' maximum dimension to the carbon nanotube alignment is from about 25° to about 2°; most preferably the angle difference for at least 50% of the fullerene supramolecular crystals' maximum dimension to the carbon nanotube alignment is from about 20° to about 3°.

Applicants disclose the article of the previous seven paragraphs wherein the aspect ratio of the fullerene supramolecular crystal outer shape is from about 1.01 and to about 10,000,000,000; preferably the aspect ratio of the fullerene supramolecular crystal outer shape is from about 1.5 and to about 100,000,000; more preferably the aspect ratio of the fullerene supramolecular crystal outer shape is from about 2 and to about 100,000; most preferably the aspect ratio of the fullerene supramolecular crystal outer shape is from about 2.5 and to about 1000. As used herein, aspect ratio means (the maximum outer dimension divided by the minimum outer dimension) as measured by Applicants' test method for fullerene supramolecular crystal aspect ratio that is found in the Test Methods section of this specification.

Applicants disclose the article of the previous eight paragraphs wherein said amorphous agglomerations of fullerenes have a maximum outer dimension of from about 1 nm to about 50 mm, preferably said amorphous agglomerations of fullerenes have a maximum outer dimension of from about 5 nm to about 100 μm, more preferably said amorphous agglomerations of fullerenes have a maximum outer dimension of from about 20 nm to about 10 μm, most preferably said amorphous agglomerations of fullerenes have a maximum outer dimension of from about 50 nm to about 1 μm.

Applicants disclose the article of the previous nine paragraphs wherein said amorphous agglomerations of fullerenes have an overall outer shape of whiskers, needles, tubular rods, rings, platelets, spheres, cubes, rhombuses, sheets, cones, ellipsoids, and/or prisms.

Applicants disclose the article of the previous ten paragraphs wherein said amorphous agglomerations of fullerenes have a maximum outer dimension, said maximum outer dimension of the amorphous agglomerations of fullerenes being oriented in the direction of the carbon nanotube alignment where the angle difference for at least 50% of the amorphous agglomerations of fullerenes maximum dimension to the carbon nanotube alignment is from about 45° degrees to about 0° degrees; preferably the angle difference for at least 50% of the amorphous agglomerations of fullerenes maximum dimension to the carbon nanotube alignment is from about 30° degrees to about 1° degrees; more preferably the angle difference for at least 50% of the amorphous agglomerations of fullerenes maximum dimension to the carbon nanotube alignment is from about 25° degrees to about 2° degrees; most preferably the angle difference for at least 50% of the amorphous agglomerations of fullerenes maximum dimension to the carbon nanotube alignment is from about 20° degrees to about 3° degrees.

Applicants disclose the article of the previous eleven paragraphs wherein the aspect ratio of the amorphous agglomerations of fullerenes' outer shape is from about 1.01 and to about 10,000,000,000; preferably the aspect ratio of the amorphous agglomerations of fullerenes' outer shape is from about 1.5 and to about 100,000,000; more preferably the aspect ratio of the amorphous agglomerations of fullerenes' outer shape is from about 2 and to about 100,000; most preferably the aspect ratio of the amorphous agglomerations of fullerenes' outer shape is from about 2.5 and to about 1000. As used herein, aspect ratio means (the maximum outer dimension divided by the minimum outer dimension) as measured by Applicants' test method for amorphous agglomerations of fullerene aspect ratio that is found in the Test Methods section of this specification.

Applicants disclose the article of the previous twelve paragraphs wherein said aligned carbon nanotubes are selected from metallic carbon nanotubes, semi-conducting carbon nanotubes and mixtures thereof.

Applicants disclose the article of the previous thirteen paragraphs wherein said aligned carbon nanotubes have an aspect ratio from about 1 to about 10,000,000,000; preferably said aligned carbon nanotubes have an aspect ratio from about 250 to about 500,000; more preferably said aligned carbon nanotubes have an aspect ratio from about 1000 to about 50,000; most preferably said aligned carbon nanotubes have an aspect ratio from about 1500 to about 14,000. As used herein, aspect ratio means (the length of the carbon nanotube divided by the maximum outer diameter of the carbon nanotube) as measured by Applicants' test method for aligned carbon nanotubes aspect ratio that is found in the Test Methods section of this specification.

Applicants disclose the article of the previous fourteen paragraphs wherein said fullerene supramolecular crystals and/or amorphous agglomerations of fullerenes comprise of C20, C60, C70, C72, C76, C84, and/or C100. In one aspect, said fullerene supramolecular crystals and/or amorphous agglomerations of fullerenes may be wholly or partially functionalized with one or more types of chemical species.

Applicants disclose the article of the previous fifteen paragraphs wherein said fullerene supramolecular crystals and/or amorphous agglomerations of fullerenes comprise endohedral fullerenes, said endohedral fullerenes comprising one or more atoms, ions and/or molecules enclosed in the fullerene spherical molecular cage.

Applicants disclose the article of the previous sixteen paragraphs wherein said fullerene supramolecular crystals and/or amorphous agglomerations of fullerenes comprise nano-onions.

Applicants disclose the article of the previous seventeen paragraphs comprising a dopant, preferably said dopant is selected from the group consisting of an alkali metal, an acid, super-acid, acid and/or super-acid derivatives, Lewis acid, an electronegative chemical species, an electropositive chemical species and mixtures thereof, more preferably said: said alkali metal is selected from the group consisting of lithium, sodium, potassium, rubidium, cesium, francium, and mixtures thereof; said acids are selected from the group consisting of nitric acid, sulfuric acid, oleum, hydrochloric acid, hydrofluoric acid, chloroauric acid, methanesulfonic acid, p-toluenesulfonic acid, and mixtures thereof; said super-acids are selected from the group consisting of fluorosulfuric acid, fluoroantimonic acid, carborane acid, Perchloric acid, Fluoroboric acid, Chlorosulfuric acid, triflic acid, triflidic acid, magic acid, and mixtures thereof; said acid and/or super-acid derivatives are composed of the product from the acid and/or super-acid reacting with the coagulant used in the production process thereof; said Lewis acid is selected from the group consisting of boron trifluoride, iodine monobromide, tin pentachloride, iron chloride, manganese chloride, iodine chloride, nickel chloride, cobalt chloride, titanium chloride, arsenic fluoride, antimony fluoride, antimony pentafluoride, arsenic pentafluoride, tantalum pentafluoride, niobium pentafluoride, and mixtures thereof; said electronegative chemical species is selected from the group consisting of iodine, bromine, chlorine, fluorine, iodine, thionyl chloride, and mixtures thereof; said electropositive chemical species is selected from the group of magnesium, calcium; strontium, barium, and mixtures thereof. In one aspect, said article comprising a dopant is encased in a sheath. When said article comprises an alkali metal dopant and/or Lewis acid dopant, or otherwise any other dopant that will react with atmospheric constituents such as oxygen and/or water vapor, said article is preferably encased in a sheath.

Applicants disclose the article of the previous paragraph wherein said dopant is disposed in or on said aligned carbon nanotubes and/or said fullerene supramolecular crystals and/or said amorphous agglomerations of fullerenes. In one aspect, said dopant resides interstitially amongst the carbon nanotubes and/or is functionalized to the carbon nanotubes, in an ordered or disordered spatial distribution, that changes the electronic charge carrier density of the carbon nanotube it is adjacent to and/or said dopant resides interstitially amongst the fullerenes and/or is functionalized to the fullerenes, in an ordered or disordered spatial distribution, that changes the electronic charge carrier density of the fullerenes it is adjacent to. In one aspect, said dopant may be introduced during the article production process as a secondary effect from the acids or their derivatives used in production and, in another aspect, dopants may be intentionally added during the manufacturing process or as a separate post process step.

Applicants disclose the article of the previous two paragraphs wherein the molar ratio of dopant and carbon atoms is about 1:1 to about 1:1000; preferably the molar ratio of dopant and carbon atoms is about 1:2 to about 1:500; more preferably the molar ratio of dopant and carbon atoms is about 1:5 to about 1:50; and most preferably the molar ratio of dopant and carbon atoms is about 1:10 to about 1:25.

Applicants disclose the article of the previous twenty paragraphs, said article being a fiber, ribbon, sheet, block, wire, rope, textile, sheath, tow, filament, or a laminate.

Applicants disclose the article of the previous twenty-one paragraphs, said article having: a tensile strength of from about 0.01 GPa to about 100 GPa, preferably said article has a tensile strength of from about 0.50 GPa to about 50 GPa, more preferably, said article has a tensile strength of from about 0.75 GPa to about 20 GPa, most preferably said article has a tensile strength of from about 1 GPa to about 10 GPa; an elongation value of from about 0.01% to about 50%, preferably said article has an elongation value of from about 0.1% to about 15%, more preferably said article has an elongation value of from about 0.5% to about 5%, most preferably said article has an elongation value of from about 1% to about 3%; and/or an electrical conductivity of from about 0.01 MSm⁻¹ to about 150 MSm⁻¹, preferably said article has an electrical conductivity of from about 0.1 MSm⁻¹ to about 80 MSm⁻¹, more preferably said article has an electrical conductivity of from about 1 MSm⁻¹ to about 30 MSm⁻¹, most preferably said article has an electrical conductivity of from about 5 MSm⁻¹ to about 20 MSm⁻¹.

Applicants disclose a finished article comprising the article according to the previous twenty-two paragraphs, said finished article being a generator; an electric motor; electrical wiring, electromagnetic tether, thermal satellite strap, vehicle armor, or personnel armor. In one aspect, said finished article is a high tensile strength and electrically conductive electrical wire forming a high power solenoid magnet; electrically conductive wire for weight critical signal and power transfer applications onboard aircraft and/or spacecraft; and/or thermally conductive conduit for weight critical thermal management onboard aerospace vehicles.

### Process of Making

For purposes of this specification, headings are not considered paragraphs and thus this paragraph. In this section titled “Process of Making” the individual number of each paragraph above and below this paragraph can be determined by reference to this paragraph. In this paragraph, Applicants disclose a process of making an article comprising carbon nanotubes, fullerene supramolecular crystals and/or amorphous agglomerations of fullerenes and comprising extruding a mixture comprising carbon nanotubes, an acid and a fullerene under a pressure of from about 100,000 psi to about 10 psi into a coagulant, preferably said process comprises extruding said mixture comprising carbon nanotubes, an acid and a fullerene under a pressure of from about 10,000 psi to about 15 psi into a coagulant, more preferably said process comprising extruding said mixture comprising carbon nanotubes, an acid and a fullerene under a pressure of from about 7,000 psi to about 50 psi into a coagulant, most preferably said process comprising extruding a mixture comprising carbon nanotubes, an acid and a fullerene under a pressure of from about 5000 psi to about 100 psi into a coagulant, preferably said coagulant is selected from the group benzene, toluene, chloroform, isopropanol, ether, acetone, diethyl ether, water and mixtures thereof. Alternatively, Applicants disclose a process of making an article comprising carbon nanotubes, fullerene supramolecular crystals and/or amorphous agglomerations of fullerenes and comprising extruding a mixture comprising carbon nanotubes and an acid under a pressure of from about 100,000 psi to about 10 psi into a coagulant comprising a fullerene, preferably said process comprises extruding said mixture comprising carbon nanotubes and an acid under a pressure of from about 10,000 psi to about 15 psi into a coagulant comprising a fullerene, more preferably said process comprising extruding said mixture comprising carbon nanotubes and an acid under a pressure of from about 7,000 psi to about 50 psi into a coagulant comprising a fullerene, most preferably said process comprising extruding a mixture comprising carbon nanotubes and an acid under a pressure of from about 5000 psi to about 100 psi into a coagulant comprising a fullerene, preferably said coagulant comprises a solvent selected from the group benzene, toluene, chloroform, isopropanol, ether, acetone, diethyl ether, water and mixtures thereof. Alternatively, Applicants disclose a process of making an article comprising carbon nanotubes, fullerene supramolecular crystals and/or amorphous agglomerations of fullerenes and comprising extruding a mixture comprising carbon nanotubes, an acid and a fullerene under a pressure of from about 100,000 psi to about 10 psi into a coagulant comprising a fullerene, preferably said process comprises extruding said mixture comprising carbon nanotubes, an acid and a fullerene under a pressure of from about 10,000 psi to about 15 psi into a coagulant comprising a fullerene, more preferably said process comprising extruding said mixture comprising carbon nanotubes, an acid and a fullerene under a pressure of from about 7,000 psi to about 50 psi into a coagulant comprising a fullerene, most preferably said process comprising extruding a mixture comprising carbon nanotubes, an acid and a fullerene under a pressure of from about 5000 psi to about 100 psi into a coagulant comprising a fullerene, preferably said coagulant is selected from the group benzene, toluene, chloroform, isopropanol, ether, acetone, diethyl ether, water and mixtures thereof.

Applicants disclose a process according to the previous paragraph wherein: said carbon nanotubes are selected from the group consisting of single-wall carbon nanotubes, double wall carbon nanotubes, multi-walled carbon nanotubes, ultrashort carbon nanotubes, small diameter carbon nanotubes, functionalized carbon nanotubes, and mixtures thereof; said carbon nanotubes are selected from metallic carbon nanotubes, semi-conducting carbon nanotubes and mixtures thereof; said fullerenes are selected from C20, C60, C70, C72, C76, C84, and/or C100 and mixtures thereof; said fullerenes being unfunctionalized; or wholly or partially functionalized with one or more types of chemical species; said fullerenes are completely or in part endohedral fullerenes; and/or—said fullerenes are completely or in part nano-onions.

Applicants disclose a process according to the previous two paragraphs wherein the acid is selected from the group consisting of sulfuric acid, fuming sulfuric acid, chlorosulfonic acid, chlorosulfuric acid, oleum, triflic acid, triflidic acid, fluorosulfonic acid, trifluoromethanesulfonic acid, perchloric acid, anhydrous hydrogen fluoride, methanesulfonic acid, p-toluenesulfonic acid, perfluoroalkanesulfonic acid, higher perfluoroalkanesulfonic acid, fluoroantimonic acid, carborane acid, perchloric acid, fluoroboric acid, triflidic acid, magic acid, and mixtures thereof.

Applicants disclose a process according to the previous three paragraphs wherein a Lewis acid is added to the acid, preferably said Lewis acid is selected from the group consisting of boron trifluoride, iodine monobromide, tin pentachloride, iron chloride, manganese chloride, iodine chloride, nickel chloride, cobalt chloride, titanium chloride, arsenic fluoride, antimony fluoride, antimony pentafluoride, arsenic pentafluoride, tantalum pentafluoride, niobium pentafluoride, antimony pentafluoride, arsenic pentafluoride, tantalum pentafluoride, niobium pentafluoride, and mixtures thereof.

Applicants disclose a process according to previous four paragraphs wherein: the carbon nanotubes are at a concentration range from about 0.01 wt % to about 50 wt % in the acid; preferably are at a concentration range from about 0.05 wt % to about 10 wt % in the acid; more preferably are at a concentration range from about 0.1 wt % to about 5 wt % in the acid; most preferably are at a concentration range from about 0.5 wt % to about 4 wt % in the acid; and/or the fullerenes are at a concentration range from about 0.01 wt % to about 50 wt % in the acid; preferably are at a concentration range from about 0.05 wt % to about 10 wt % in the acid; more preferably are at a concentration range from about 0.1 wt % to about 5 wt % in the acid; most preferably are at a concentration range from about 0.5 wt % to about 4 wt % in the acid.

Applicants disclose a process according to previous five paragraphs wherein the mixture comprising carbon nanotubes, acid and fullerenes are heated before extrusion and/or during extrusion to a temperature from about 20° C. to about 500° C.; preferably to about 50° C. to about 250° C.; more preferably to about 100° C. to about 200° C.; most preferably to about 120° C. to about 175° C.

Applicants disclose a process according to the previous six paragraphs wherein said article is drawn out after extrusion, said drawing out being conducted before, during and/or after coagulation, wherein at least a portion of the article is under tension where the tension force is from about 0 N to about 10,000 N, preferably where the tension force is from about 0.01 N to about 1,000 N, more preferably where the tension force is from about 0.1 N to about 100 N, most preferably where the tension force is from about 0.2 N to about 10 N, preferably said article is continuously drawn out.

Applicants disclose a process according to the previous seven paragraphs wherein said article, after coagulation, is dried and/or annealed, preferably said drying and/annealing comprises subjecting said article to radio waves, microwaves, millimeter waves, terahertz waves, infrared light, visible light, ultraviolet light, infrared heat, convective heat, acoustic drying, conductive heat and/or ohmic heat by passing an electrical current through the article. In one aspect, said drying and/annealing is conducted under vacuum or partial vacuum. In another aspect, said drying and/annealing is conducted in an atmosphere comprising a gas selected from the group consisting of helium, neon, argon, krypton, xenon, nitrogen, sulfur hexafluoride, carbon dioxide, hydrogen, methane and mixtures thereof.

Applicants disclose a process according to the previous paragraph wherein said article, after coagulation, is dried and/or annealed, preferably said drying and/annealing comprises subjecting said article to convective heat and/or thermal radiation, by passing the article through a furnace or oven, in one aspect, said drying and/annealing is conducted under vacuum or partial vacuum, in another aspect, said drying and/annealing is conducted in an atmosphere comprising a gas selected from the group consisting of helium, neon, argon, krypton, xenon, nitrogen, sulfur hexafluoride, carbon dioxide, hydrogen, methane and mixtures thereof.

Applicants disclose a process according to the previous nine paragraphs wherein said article is doped with a dopant by direct exposure of the dopant to the article and/or the article's constituents where the dopant is in a liquid and/or vapor phase and is absorbed into the article and/or the article's constituents: after the article has been dried and/or annealed; after the article has been drawn; while the drawing process is occurring; while the coagulation process is occurring; while the extrusion process is occurring; before the extrusion process while the carbon nanotubes, acid, and fullerenes are still a mixture; and/or before the carbon nanotubes, acid, and fullerenes are mixed together. The dopant changes the electronic charge carrier density of the carbon nanotube and/or the fullerenes it is adjacent to; said dopant resides interstitially amongst the carbon nanotubes and/or fullerenes and/or is functionalized to the carbon nanotubes and/or fullerenes, in an ordered or disordered spatial distribution.

Applicants disclose a process according to the previous paragraph where the dopant is selected from the group consisting of an alkali metal, an acid, super-acid, acid and/or super-acid derivatives, Lewis acid, an electronegative chemical species, an electropositive chemical species and mixtures thereof, more preferably said: said alkali metal is selected from the group consisting of lithium, sodium, potassium, rubidium, cesium, francium, and mixtures thereof; said acids are selected from the group consisting of nitric acid, sulfuric acid, oleum, hydrochloric acid, hydrofluoric acid, chloroauric acid, methanesulfonic acid, p-toluenesulfonic acid, and mixtures thereof; said super-acids are selected from the group consisting of fluorosulfuric acid, fluoroantimonic acid, carborane acid, perchloric acid, fluoroboric acid, chlorosulfuric acid, triflic acid, triflidic acid, magic acid, and mixtures thereof; said acid and/or super-acid derivatives are composed of the product from the acid and/or super-acid reacting with the coagulant used in the production process thereof; said Lewis acid is selected from the group consisting of boron trifluoride, iodine monobromide, tin pentachloride, iron chloride, manganese chloride, iodine chloride, nickel chloride, cobalt chloride, titanium chloride, arsenic fluoride, antimony fluoride, antimony pentafluoride, arsenic pentafluoride, tantalum pentafluoride, niobium pentafluoride, and mixtures thereof; said electronegative chemical species is selected from the group consisting of iodine, bromine, chlorine, fluorine, iodine, thionyl chloride, and mixtures thereof; said electropositive chemical species is selected from the group of magnesium, calcium, strontium, barium, and mixtures thereof.

Applicants disclose a process according to the previous two paragraphs wherein said article is heated, while being doped, to a temperature from about 20° C. to about 3500° C., or to a temperature from about 20° C. to about 2000° C., preferably to a temperature from about 50° C. to about 1000° C.; more preferably to a temperature from about 100° C. to about 500° C.; most preferably to a temperature from about 200° C. to about 400° C., preferably said heating is conducted under an inert atmosphere, more preferably said inert atmosphere is under a partial vacuum.

Suitable processing acids, such as chlorosulfonic acid (CSA), and suitable fullerenes, such as C60, can be obtained from Sigma-Aldrich (PO Box 14508 St. Louis, MO 68178 USA). Suitable few-walled carbon nanotubes (CNTs) can be purchased from Meijo Nano Carbon Co (2271-129 Anagahora, Shimoshidami, Moriyama, Nagoya 460-0002, Japan).

Suitable high-pressure, stainless steel syringe pumps and syringes can be obtained from Chemyx Inc (10905 Cash Rd, Stafford, TX 77477 USA). Suitable speed mixers can be obtained from Hauschild Engineering (37735 Enterprise Ct, Farmington Hills, MI 48331).

### Test Methods

The test methods below should be used to determine the properties of Applicants articles as listed in such test methods.

The co-presence of carbon nanotubes (CNTs) and fullerene supramolecular crystals comprising the article, as well as their degree of microstructure alignments, may be determined by wide angle X-ray diffraction (WAXD). The preferred wide angle diffraction (WAXD) configuration is transmission mode, although for particularly thick samples (greater than about 100 μm) then the more typical reflection configuration is acceptable. The Cu Ku wavelength of 1.5406 Å should be used. The sample should be tested at ambient temperature. Our transmission wide angle X-ray diffraction (WAXD) measurements were accomplished with a Xenocs Xeuss 3.0 with a Pilatus 300 K detector and, in general, a comparable wide angle X-ray diffraction (WAXD) system in terms of performance should be used. All samples were run in the line eraser mode for 10800 seconds per exposure. Line eraser mode is used to remove horizontal bars that occur in the data due to the design of the detector. A total of two exposures per sample were collected at a sample to detector distance of 55 mm using the standard configuration. The detector was offset from center (35 mm in x and 45 mm in z) in order to collect one full quadrant of the pattern.

Depending on the nano-scale or sub-nanoscale crystalline features of the article, in general, the intensity of the wide angle X-ray diffraction (WAXD) scattering profile will have prominent peaks as a function of the scattering vector Q or equivalently the 2θ scattering angle. For few-walled carbon nanotubes (CNTs) (typically consisting of one, two, or three concentric tubular shells), there is the (002) X-ray intensity peak associated with: 1) the van der Waals spacing amongst neighboring few-walled carbon nanotubes (CNTs) comprising a bundle, the typical aligned agglomerations of carbon nanotubes (CNTs) manifested by van der Walls or electrostatic forces; and/or 2) the regular spacing of concentric tubular shells within individual carbon nanotubes (CNTs). This (002) peak is at about, nominally, 2θ=25° degrees (equivalently about, Q=1.7 Å⁻¹ or d spacing=3.5 Å) and generally ranges from about 2θ=20° degrees (equivalently about, Q=1.4 Å⁻¹ or d spacing=4.4 Å) to about 2θ=28° degrees (equivalently about, Q=2.0 Å⁻¹ or d spacing=3.2 Å). Multiwall carbon nanotubes (CNTs) (consisting of more than three concentric tubular shells) will tend to have a larger and sharper (002) peak because of a greater number of wall-to-wall domains, although tend to not bundle together. Typical carbon nanotube (CNT) diffraction peaks also happen at higher 2θ angles (typically, greater than about 2θ=40° degrees) from structure on the individual carbon nanotube (CNTs). The (110), (101), and (100) peaks for example reflect the atomic structure of the graphene sheet that forms the carbon nanotube (CNT). These positions of all of these X-ray diffraction peaks are given in ranges because the structure, packing, and overall wall to wall spacing changes amongst different carbon nanotube (CNT) materials. Further, foreign chemical species meant to electronically dope, cross link carbon nanotube (CNT) structures together, or otherwise alter the material properties may skew or obscure the carbon nanotube (CNT) X-ray diffraction peaks, as well as possibly add new X-ray diffraction peaks.

Fullerenes are known to self-assemble by themselves into larger supramolecule crystals with specific crystal structure, degree of order, and overall dimensions as a function of the types of fullerenes used, as well as process conditions, such as utilized solvents and annealing circumstances; this leads to a wide variety of possible wide angle X-ray diffraction (WAXD) diffraction patterns. A common wide angle X-ray diffraction (WAXD) peak in many C60 crystals, for example, is formed by the van der Waals C60-C60 distance nominally from about 9.95 Å to about 10 Å. Sometimes covalent bonding amongst C60 molecules in a dimer or polymerization process has been responsible for shortening this distance from about 9.13 Å to about 9.34 Å. These distances correspond to a scattering angle ranging from about 2θ=8° degrees (equivalently about, Q=0.56 Å⁻¹) to about 2θ=11.5° degrees (equivalently about, Q=0.82 Å⁻¹). Face centered cubic (FCC) is atypical example of a crystal structure formed from the ordered assembly of C60 molecules into a larger supra molecular crystal. This can lead to multiple diffraction peaks at about 2θ=10.85° degrees (equivalently about, Q=0.77 Å⁻¹) and 2θ=17.73° degrees (equivalently about, Q=1.26 Å⁻¹) and 0=20.82° degrees (equivalently about, Q=1.47 Å⁻¹) and 0=21.74° degrees (equivalently about, Q=1.53 Å⁻¹). These face centered cubic (FCC) peak positions of the C60 supra molecular crystal can vary up to about 1.5° degrees, and other additional peaks may be present, depending on processing conditions such as solvents used and annealing and/or drying procedures. Other sets of X-ray diffraction patterns would be expected with different fullerenes and/or different crystal structures. For example, bulk C60 crystals with a face centered cubic (FCC) crystal structure at room temperature changes into a simple cubic (SC) crystal structure below about 260 K−(−13° C.). Addition of dopant chemical species would also be expected to alter the wide angle X-ray diffraction peaks.

Crystalline solids will show sharp high intensity peaks in respect to scattering angle for wide angle X-ray diffraction (WAXD) and with amorphous solids these peaks are broad and have lower intensity. These fullerene agglomerations are considered crystalline if a majority of their scattering angle 2θ wide angle X-ray diffraction (WAXD) peaks have a full width half maximum (FWHM) of less than 7° degrees. Before analysis of the full width half maximum (FWHM), these peaks must by numerically deconvoluted from other peaks that may add to it.

Microstructure alignment of both the carbon nanotubes (CNTs) and fullerene crystals may also be identified with wide angle X-ray diffraction (WAXD). The azimuthal angle ψ represents the degree of rotation of the article, with rotation around the axis formed by the beam of X-rays and the plane of rotation normal to the X-ray beam. In practice, the sample under test rarely physically rotates. In more typical reflection configurations, for example, the wide angle X-ray diffraction (WAXD) source and detector instead physically rotates around the sample. In our preferred measurement configuration, transmission wide angle X-ray diffraction (WAXD), the positioning of the source and detector enables scattering to be collected across a wide sector of azimuthal angles ψ at once without any physical rotation. In general, a crystal structure lacks alignment if the intensity of all its wide angle X-ray diffraction (WAXD) 2θ diffraction peaks does not depend on the azimuthal ψ going from zero to 180° degrees. If the intensity of some wide angle X-ray diffraction (WAXD) 2θ diffraction peak repeatably varies with the azimuthal angle ψ going from zero to 180° degrees, then there is alignment associated with that crystal structure generating that wide angle X-ray diffraction (WAXD) 2θ diffraction peak. The degree of microstructure alignment associated with a particular wide angle X-ray diffraction (WAXD) 2θ diffraction peak is determined by measuring the intensity of the peak at its 2θ location and varying the azimuthal angle ψ from zero to 180° degrees where an azimuthal angle of 90° degrees is positioned to the angle of the suspected microstructure alignment. If alignment is present, the dependence of intensity on azimuthal angle will form at least one azimuthal-dependent peak. For a given 2θ feature, the full width half maximum (FWHM) of the most intense azimuthal-dependent peak across the prescribed azimuthal scan is the degree of microstructure alignment of the crystal structure generating the 2θ feature. A smaller full width half maximum (FWHM) represents a greater degree of alignment. For a given 2θ feature, the azimuthal angular position of the most intense azimuthal-dependent peak across the prescribed azimuthal scan is the alignment angle of that crystalline feature.

For carbon nanotubes (CNTs), the wide angle X-ray diffraction (WAXD) 2θ diffraction peak selected for observation of azimuthal dependence is the (002) peak, which is nominally at about 2θ=25° degrees (equivalently about, Q=1.7 Å⁻¹ or d spacing=3.5 Å) and generally ranges from about 2θ=20° degrees (equivalently about, Q=1.4 Å⁻¹ or d spacing=4.4 Å) to about 2θ=28° degrees (equivalently about, Q=2.0 Å⁻¹ or d spacing=3.2 Å). If this (002) peak has alignment, then the CNTs are considered aligned with the specified alignment angle. If this (002) peak is unavailable or unobscured, then any wide angle X-ray diffraction (WAXD) 2θ diffraction peak associated with the carbon nanotubes (CNTs) may be selected for observation of azimuthal dependence. If any one or more of these wide angle X-ray diffraction (WAXD) 2θ diffraction peaks have alignment, then the CNTs are considered aligned with the specified alignment angle. For situations where multiple wide angle X-ray diffraction (WAXD) 2θ diffraction peaks provide different alignment angles, the alignment angle closest to the angle of suspected microstructure is selected. In this case of carbon nanotubes (CNTs)—for morphologies such as a wire, fiber, ribbon, filament, or tow—the suspected microstructure alignment is in the direction of the wire, fiber, ribbon, filament, or tow. For more planar, laminate, or bulk morphologies, the suspected microstructure alignment is in the direction of flow or extrusion used in the production process, relative to the overall morphology.

For fullerene agglomerations (be it crystalline or amorphous), any wide angle X-ray diffraction (WAXD) 2θ diffraction peak associated with the fullerenes may be selected. If any one or more of these wide angle X-ray diffraction (WAXD) 2θ diffraction peaks have alignment, then the fullerene is considered aligned with the specified alignment angle. For situations where multiple wide angle X-ray diffraction (WAXD) 2θ diffraction peaks provide different alignment angles, the alignment angle closest to the angle of suspected microstructure is selected. For fullerene crystals, the angle of suspected microstructure alignment is the alignment angle of the carbon nanotubes (CNTs).

Wide angle X-ray diffraction (WAXD) measurements can identify the novel material we disclose here as a partial or full superposition of 1) a wide angle X-ray diffraction (WAXD) measurement of aligned carbon nanotubes (CNTs) with 2) a wide angle X-ray diffraction (WAXD) measurement of a fullerene crystal and/or amorphous fullerene agglomeration (with or without alignment). This identification is accomplished by comparing it with 1) known wide angle X-ray diffraction (WAXD) 2θ diffraction patterns in literature and/or 2) as experimentally determined by preparing and measuring fullerene crystals by themselves. It is known that other wide angle X-ray diffraction (WAXD) 2θ peaks may be present or peak shifting may occur (up to 1.5° degrees) from other factors such as residual solvents, acids, or dopants.

Polarized Raman spectroscopy is accomplished under a Renshaw 514 nm wavelength Raman laser with Raman laser polarization in directions parallel and perpendicular to the angle of suspected microstructure alignment, all at the same location on the sample. In cases where the carbon nanotube (CNT) alignment angle is present and known, the angle of suspected microstructure alignment is the carbon nanotube (CNT) alignment angle. In situations where the carbon nanotube (CNT) alignment angle is not known—and for morphologies such as a wire, fiber, ribbon, filament, or tow—the angle of suspected microstructure alignment is in the direction of the wire, fiber, ribbon, filament, or tow. In other situations where the carbon nanotube (CNT) alignment angle is not known—and for more planar, laminate, or bulk morphologies—the angle of suspected microstructure alignment is in the direction of flow or extrusion used in the production process, relative to the overall morphology. In all other situations, the angle of suspected microstructure alignment is the angle where the G peak has the strongest intensity with the polarized Raman laser as the sample is rotated over one location on the sample from 0° to 360° degrees. The G peak is the prominent Raman spectroscopy peak at about 1570 cm⁻¹ to 1608 cm-1 wavenumbers associated with tangential vibrations on carbon nanotubes (CNTs) and graphene. Typically, a 50× objective is used although more critically it is important the laser spot remain completely on the sample for both parallel and perpendicular measurements. In terms of Raman laser power, dwell time on the sample, and number of accumulations, it is important these parameters are low enough to not burn, harm, or irreversibly change the sample. This is accomplished by ensuring the Raman signal does not change when conducting serial measurements at the same location on the sample. On the other hand, the Raman laser power, dwell time on the sample, and number of accumulations must be sufficiently high to get an adequate signal to noise ratio in both the parallel and perpendicular measurement configurations to observe the carbon nanotube (CNT) and fullerene features. This is defined as a G peak with intensity at least twelve times greater than the average peak to peak magnitude of the noise. Once Raman laser settings are established, it is important they do not change from the parallel and perpendicular measurements.

Aligned carbon nanotubes (CNTs) can be identified by a Raman G peak intensity that increases, on average, at least 50% going from the Raman laser polarization perpendicular to the angle of suspected microstructure alignment to the Raman laser polarization parallel to the angle of suspected microstructure alignment. Generally, the greater the increase in the G peak the greater the alignment, although this metric is qualitative and not quantitative. Embedded fullerene agglomerations (be it amorphous or crystalline) amongst the carbon nanotubes (CNTs) can be identified by observing a Raman spectrum going from a spectrum more resembling a carbon nanotube (CNT) spectrum (with the Raman laser in the parallel configuration, where the CNT Raman signal is amplified from the antenna effect), to one that more resembles a fullerene Raman spectrum. Different fullerenes with different crystal structures may yield different Raman spectra. In general, the suspected fullerene spectra that becomes increasing apparent going from a Raman laser in a parallel configuration to a perpendicular configuration should be compared to 1) known Raman spectra of fullerenes in literature and/or 2) experimentally measured Raman spectra by preparing and measuring fullerene agglomerations by themselves. For C60 fullerenes in particular, as the Raman laser moves from the parallel to the perpendicular configuration, there will be a decrease in the G peak and the growth of a prominent Raman spectroscopy peak appearing at, nominally, 1460 cm⁻¹ wavenumbers although this can range from about 1440 cm⁻¹ to 1485 cm⁻¹ wavenumbers. The higher the C60 concentration, the greater the magnitude relative to other Raman spectroscopy peaks. At least five randomly selected locations on the sample should be tested to obtain an average.

Transmission electron microscopy (TEM) is able to directly observe carbon nanotube (CNT) alignment, the carbon nanotube (CNT) aspect ratio, the outside dimensions of the fullerene agglomerations, the orientation of the fullerene agglomerations, and the degree of crystallinity and crystal structure of the fullerene agglomerations. The sample for transmission electron microscopy (TEM) was prepared by first manually dicing 1 mm fiber segments with a razor blade which were then carefully placed onto a molybdenum transmission electron microscopy (TEM) mesh grid that was coated in EpoTek 353ND epoxy. The grid and sample were allowed to cure overnight at room temperature after which a few nanometers of Ir were deposited onto the grid for conductivity. The diced fiber segment was then thinned to electron transparency in a Tescan Lyra2 Ga+ FIB at 30 kV and finished with a 5 kV final polish. A Thermo Fisher Scientific Talos operating at 200 kV was used to image the lamella and take selected area diffraction patterns.

In terms of a fullerene agglomeration, the maximum outer dimension is defined as the longest dimension of a rectangular box that is just big enough to contain the overall fullerene agglomeration, be it crystalline or amorphous. This maximum outer dimension can have an orientation that is typically in the direction of the carbon nanotubes (CNTs). The minimum outer dimension is defined as the shortest dimension of a rectangular box that is just big enough to contain the overall fullerene agglomeration, be it crystalline or amorphous. Aspect ratio for fullerene agglomerations is defined as the maximum outer dimension divided by the minimum outer dimension. These dimensions, the orientation of the long dimension, and crystallinity of the fullerene agglomerations may be measured with the transmission electron microscopy (TEM) procedures outlined in the paragraph above.

In terms of carbon nanotubes (CNTs), aspect ratio is defined as the length of the carbon nanotube (CNT) divided by the maximum outer diameter of the carbon nanotube (CNT). This aspect ratio can be directly measured in a transmission electron microscope (TEM) where the stock carbon nanotubes (CNTs) are imaged where stock means that the carbon nanotubes (CNTs) are in the condition as they would be right before they are mixed with the acid and fullerenes. Alternatively, the aspect ratio may be obtained by again measuring these stock carbon nanotubes (CNTs) and employing the procedures outlined in D. Tsentalovich, et al., Relationship of Extensional Viscosity and Liquid Crystalline Transition to Length Distribution in Carbon Nanotube Solutions, Macromolecules 2016, 49, 681-689.

Electrical conductivity is measured by a standard four probe technique with a probe current sufficiently low to not appreciably heat up the sample, which should be less than 0.1° C. The exact probe current and heating conditions is sample and test setup specific, although probe currents less than 100 Å are typically adequate for substrate-supported fiber-like samples about 20 μm in diameter and about 5 mm long. The distance from one inner lead to the other inner lead of the four probe setup should be significantly greater than the individual carbon nanotube (CNT) length. Typically, inner lead separation greater than 1 mm is sufficient. Probe test leads can be fixed to the article under test with silver paint. Mechanical tensile strength is measured with a tensile tester under a constant stretching rate as measured in millimeters per minute, such that the constant stretching rate is set to a numerical value of 10% of the initial gauge length, which is measured in millimeters. The initial gauge length should be 10 mm or greater. The clamp length should be long enough and sufficiently fixed to the clamps such that the sample does not appreciably slip in the clamps. Electrical conductivity and mechanical tensile strength also requires measurement of the conductor cross-section and, in our method, we use a scanning electron microscope (SEM) for this task. The article is cut with a blade and the freshly exposed cross-section is measured with the scanning electron microscope (SEM).

### EXAMPLES

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

Example 1: Mechanically stronger carbon nanotube (CNT) fiber by integration of aligned, lower concentration C60 crystals. C60 powder and few-walled carbon nanotubes (CNTs) are thoroughly mixed in chlorosulfonic acid (CSA) with a speed mixer with the following amount (0.2% C60, 2% carbon nanotube (CNT), 97.8% chlorosulfonic acid (CSA) by wt % at mixing). The few-walled carbon nanotubes (CNTs) are best if they have radial breathing modes in Raman spectroscopy at some Raman wavelength and Raman G:D ratios of 20 or greater. Using a syringe pump, the carbon nanotube (CNT) C60 solution is extruded into a coagulant bath such as acetone or water. This creates a fiber that is wound on a rotating wheel where care is taken to keep maximum tension on the fiber without breaking it for maximum microstructure alignment and density. For these carbon nanotube (CNT) C60 concentrations, examples of the collection speed of the rotating wheel are 2.7 m/min and for the extrusion rate at the syringe pump is 2 m/min. This yields a draw ratio of 1.35. Depending on viscosity and fiber continuity, these parameters may be adjusted to maintain the constant draw ratio. The highest practical draw ratios achieved thus far are 1.5. Adding C60 in this lower concentration increases the mechanical properties such as a doubling of the tensile strength over the neat carbon nanotube (CNT) fiber. Residual species from the acid processing may be removed and the crystallinity of the aligned C60 agglomerations may be improved by annealing. An example of this beneficial annealing, which does not damage the C60 molecules themselves, is heat treatment at 300° C. in ultra-pure argon for 1 hour.

Example 2: Stable-doped carbon nanotube (CNT) fullerene fibers for higher conductivity. The same as example 1, although with the added processing step of introducing doping chemical species such as bromine, iodine, or iron chloride. This doping chemical species can be directly introduced in the form of a vapor, where the chemical species is heated to the point of sufficient vaporization or sublimation, and the carbon nanotube (CNT) fullerene host material is heated at a slightly higher temperature to avoid bulk recrystallization on the surface. Alternatively, the doping chemical species can also be dissolved into a suitable solvent, such as toluene, and the carbon nanotube (CNT) fullerene host material is then submerged into the solution. After introduction, the doping chemical species will reside amongst the carbon nanotubes (CNTs) as well as the fullerenes. This has the effect of increasing the carrier density and overall conductivity of the carbon nanotubes (CNTs) and fullerenes crystals, leading to fiber conductivities greater than copper on the basis of weight. Further, the doping chemical species can bond with the fullerenes in specified stoichiometries. The benefit is that this bonding modifies the electronegativity of the fullerene crystals and increases the carrier density and conductivity of the local carbon nanotube (CNT) network in a way that is more chemically stable with respect to temperature, time, and exposure to outside environment, relative to doping chemical species intercalation where no chemical bonding occurs. The material may be coated with a sheath made from metal or polymer for the purposes of insulation and further increasing the stability of the material.

Example 3: Mechanically strong and bendable superconducting fiber. The same as example 1 except a higher fullerene concentration is used, such as one with the following mass percentage (2% C60, 2% carbon nanotube (CNT), 96% chlorosulfonic acid (CSA) by wt %). This increases the size of the aligned fullerene crystals and the likelihood of a percolative path for the fullerenes. Particularly after annealing, these fibers may be exposed to alkali metal vapors for doping. This is typically accomplished by sealing the annealed fullerene carbon nanotube (CNT) fiber (typically 6 inches long) in an evacuated quartz tube with alkali metals (typically potassium, 0.5 to 1 g). This sealed quartz vessel and its contents is then heated for days to weeks at 200° C. to 300° C. in a standard tube furnace. The fullerene carbon nanotube (CNT) fiber doped with alkali metals is sensitive air and measures are required to protect it from the outside environment, say with a sheath. This material may be cooled to cryogenic temperatures such that the aligned and doped fullerene molecules become superconductive starting at some critical temperature. Provided there is a sufficient superconducting percolative path, the DC resistance of the overall material goes to zero below its critical temperature. In this case, the role of the carbon nanotube (CNT) is to provide robust mechanical support for the aligned and doped fullerene percolative path, as well as provide an ohmic bypass shunt (sometimes called a stabilizer) in case the superconductivity fails. The carbon nanotube (CNT) network may also support superconducting charge carriers through an induced superconductivity mechanism associated with its locality to the superconductivity of the aligned and doped fullerene crystals.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and process, and illustrative examples shown and described. Accordingly, departures may be made from such details without departing from the scope of the general inventive concept.

What is claimed is:

1. An article comprising:
a) aligned carbon nanotubes; and
b) fullerene supramolecular crystals derived from C60 and/or amorphous agglomerations of fullerenes derived from C60.
